(19) United States
(12) Patent Application Publication
(10) Pub. No.: US 2022/0103537 A1
(43) Pub. Date: Mar. 31, 2022

(54) CANNABIS IDENTITY VERIFICATION AND EXCHANGE PLATFORM

(71) Applicants: Timothy John Los, Los Angeles, CA (US); Jacob Johnson, Bay Minette, AL (US)

(72) Inventors: Timothy John Los, Los Angeles, CA (US); Jacob Johnson, Bay Minette, AL (US)

(73) Assignee: Rante Corporation, Santa Monica, CA (US)

(21) Appl. No.: 17/033,254

(22) Filed: Sep. 25, 2020

(51) Int. Cl. H04L 29/06; G06N 5/02; H04L 29/08

(52) U.S. Cl. CPC H04L 63/08; H04L 67/306; G06N 5/02

(57) ABSTRACT

A cannabis identification verification platform allows for users and entities to validate the identity of an individual involved, either directly or indirectly, in the cannabis industry to address laws and regulations on a federal, state, and local level. The identity verification can occur when conducting cannabis sales, dealing with cannabis vendors, accessing a cannabis facility, and when individuals access cannabis websites for either informational or ecommerce experiences. The identity verification platform allows businesses, whether directly or indirectly in the cannabis industry, to verify individuals based upon their own rules and processes with different data metrics. In addition, the identity verification platform allows cannabis data to be exchanged and shared to provide additional metrics to identify an individual between organizations and government entities.

### CROSS-REFERENCE TO RELATED APPLICATIONS

This application may be related to the subject matter of U.S. patent application Ser. No. 16/812,576, filed Mar. 9, 2020, and U.S. patent application Ser. No. 16/994,316, filed Aug. 14, 2020 by the same applicant.

### BACKGROUND

The embodiments herein relate generally to data processing, and more particularly to a system, platform, and process for cannabis identity verification and exchange of information.

In general, cannabis related businesses have a wide range of regulations they must comply with. In some cases, a cannabis related business may run afoul of a regulation. In some cases, the business itself does not intentionally violate a regulation but a consumer or client is themselves violating a rule or law which puts the cannabis business at risk.

As can be seen, there is a need for a system that assist cannabis seller businesses identify individuals which may put the business at a risk.

### SUMMARY

In one aspect of the subject disclosure, a computer program product for an online host platform verifying an identification of a cannabis purchasing individual comprises a non-transitory computer readable storage medium having computer readable program code embodied therewith. The computer readable program code is configured to: host, through a computer server, the online host platform, wherein the online host platform is part of a computer network; generate and host user interfaces for a plurality of user accounts, wherein the plurality of user accounts communicate with the computer server through the computer network; receive by the computer server from one of the plurality of user accounts, identity data of the cannabis purchasing individual; determine by the computer server, whether the identity data of the cannabis purchasing individual raises a flag associated with the cannabis purchasing individual; and generate for display through the user interfaces, the flag associated with the cannabis purchasing individual.

In another aspect, a method for an online host platform verifying an identification of a cannabis purchasing individual is disclosed. The method comprises: hosting, through a computer server, the online host platform, wherein the online host platform is part of a computer network; generating and host user interfaces for a plurality of user accounts, wherein the plurality of user accounts communicate with the computer server through the computer network; receiving by the computer server from one of the plurality of user accounts, identity data of the cannabis purchasing individual; determining by the computer server, whether the identity data of the cannabis purchasing individual raises a flag associated with the cannabis purchasing individual; and generating for display through the user interfaces, the flag associated with the cannabis purchasing individual

### BRIEF DESCRIPTION OF THE FIGURES

The detailed description of some embodiments of the invention is made below with reference to the accompanying figures, wherein like numerals represent corresponding parts of the figures.

FIG. 1 is a block diagram of a system environment in which a cannabis exchange system operates, in accordance with an embodiment.

FIG. 2 is a flowchart of how a user is identified within the cannabis identity system, in accordance with an embodiment.

FIG. 3 is a flowchart of how user data is analyzed and compared and the identification process within the cannabis identity system, in accordance with an embodiment. The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF CERTAIN EMBODIMENTS

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. Like or similar components are labeled with identical element numbers for ease of understanding.

In general, embodiments of the disclosed subject technology improve on identification processes when engaging with customers during a consumer visit, whether online or in-person. An electronic identity verification platform may be provided by the subject technology, such as through an online system or through an Automatic Programming Interface (API) integrated within another system. The platform provides users and entities with validated data about their customers through a user interface (UI). This validation helps identify an individual who either enter their premises, accesses their web site for either informational or ecommerce purposes, or to conduct a sale in-person to address local, state, and federal regulations. Further, the identity verification platform allows a business to adhere to their own compliance procedures. In addition, the identity verifications platform may be configured for businesses and governments to exchange (through respective UIs) verified customer information bi-directionally for enhanced compliance.

The identity verification platform provides organizations with a process to identify their vendors' employees; further, the identity verification platform, coupled with Determining a Metric and Predictive Analysis for Cannabis Compliance (U.S. Ser. No. 16/812,574) and Cannabis Compliance and Exchange Platform (U.S. Ser. No. 16/994,316) provides the user with verifying a cannabis business, related transactions, and the employee involved in the transaction.

The identity verification platform provides a centralized platform to evaluate individuals based upon a variety of data points. This is achieved through internal data, geographic data, third-party systems, and data exchanged (“data sources”). These data sources are merged within custom controls that allow the users to define their own rules and logics when identifying an individual. These rules and logical statements, inclusive of conditional statements, are configurable based upon different data sources and can either be weighted, prioritized, or excluded when identifying an individual. Internal data sources are those owned and managed by the user. Geographic data sources are focused on the residency of the individual and IP address of visitors to cannabis-related websites. Third-party systems are data sources in which users can connect to from outside the identity verification platform. Data exchange systems allow for users to verify identities between different organizations.

The identity verification platform allows businesses to verify their customers and vendor employees either online or in-person. Whether through an app or website portal, customers can complete required information to verify their identity and age, where applicable. During the purchasing process, the business can verify the customer's identity. This can include reading the barcode of a driver's licenses, as well as comparing the customer's information from the identity verification platform that was shared by other businesses. The data sources to be used by the business, as well as their effective weight, is based upon the user's configurations.

The identity verification platform is configured to allow a business to ensure their online presence is viewed within the scope of local, state, and federal regulations; in addition, the identity verification platform provides a tool to ensure ecommerce transactions are from verified individuals.

The identity verification platform allows for data exchange, regardless of whether it is connected through the Cannabis Compliance and Exchange Platform. This data exchange allows organizations and government entities, inclusive of individual users, to exchange the collected data of individuals in which they interact, where applicable. The sharing of collected information provides users within the system the ability to compare data of individuals to combat identity transgressions. In one exemplary implementation of the subject technology, an individual has used the same name but different address and date of birth at different locations using the system. This information is shared and compared when the individual visits other establishments and/or websites. The system may flag the individual for other Through the identity verification platform, a business can determine that this individual presents a high-risk as their information is inconsistent at different locations.

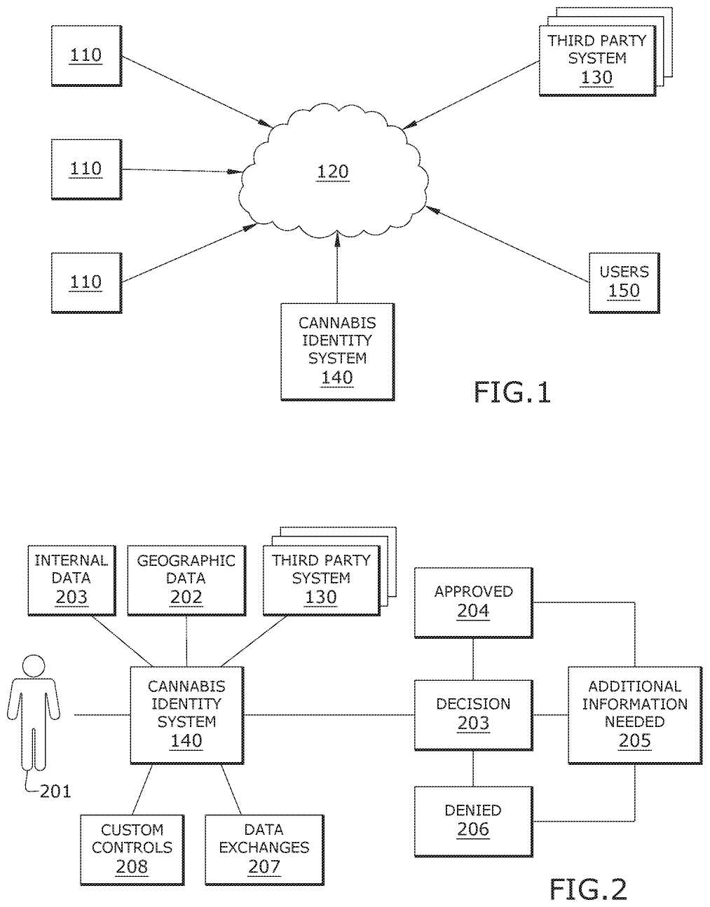

FIG. 1 shows a high-level block diagram of a system environment 100 for a cannabis identity system 140 according to an exemplary embodiment. The system environment 100 comprises one or more client devices 110, a network 120, one or more third party systems 130, the exchange system 140, one or more user or entity 150, and data input 160. The embodiments described herein can be adapted to other suitable online systems and backend systems, including offline environments in which a network 120 is either not required or an intranet.

The client devices 110 are one or more computing devices capable of receiving user input as well as transmitting and/or receiving data via the network 120. The crawlers 160 are one or more systems capable of receiving data from public and private sources on the internet as well as transmitting and/or receiving data via the network 120. In one embodiment, a client device 110 is a conventional computer system, such as a desktop or laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the cannabis identity system 140. For example, a client device 110 executes a browser application to enable interaction between the client device 110 and the cannabis identity system 140 via the network 120. In another embodiment, a client device 110 interacts with the cannabis identity system 140 through an application programming interface (API) running on a native operating system of the client device 110, such as but not limited to IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML).

FIG. 2 is a flowchart of either a customer or visitor (“individual”) 201 visiting either a cannabis store or website according to an exemplary embodiment. The individual 201 enters their information within the cannabis identity system 140. The individual's information can include, but not limited to their full name, address, driver's license information (including the barcode), and social security information (“personally identifiable information”). The Personally Identifiable Information is compared against internal data 203, geographical data 202, and third-party systems 130. In one embodiment, a user 150 may configure an internal database 203 of those who are “blacklisted” by the user 150. In another embodiment, the user 150 may configure a third-party system 130 that validates the driver's license of the individual to ensure it is legitimate. In addition, a user 150 may configure custom controls 208 and exchange or receive exchanged data 207 to validate the individual 201. In one embodiment, data may be exchanged 207 between different users 150 within the cannabis identity system 140 to provide additional verification; for example, the system may be configured so that users 150 can share different data metrics and outcomes on an individual 201. In another embodiment, a user 150 may compare exchanged cannabis data 207 against either their internal data 203 and third-party systems 130 of a particular individual 201 to identity and verify the individual 201 prior to either entering their store, completing a purchase, or visiting a website. Based upon the information being used to validate the individual 201 within the cannabis identity system 140, the system may make a decision 205, as based upon the custom controls 208 configured by the user 150. A decision may be for example, an approval 204, denial 206, or a request for additional information 209. In one embodiment, the user 150 may configure custom controls 208 that include third-party systems 130 and data exchanges 207 with other users of the cannabis identity system 140. Based upon the configuration, the data may be compared against the individual 201 to decide 205 whether to either complete a transaction or enter either the office or website.

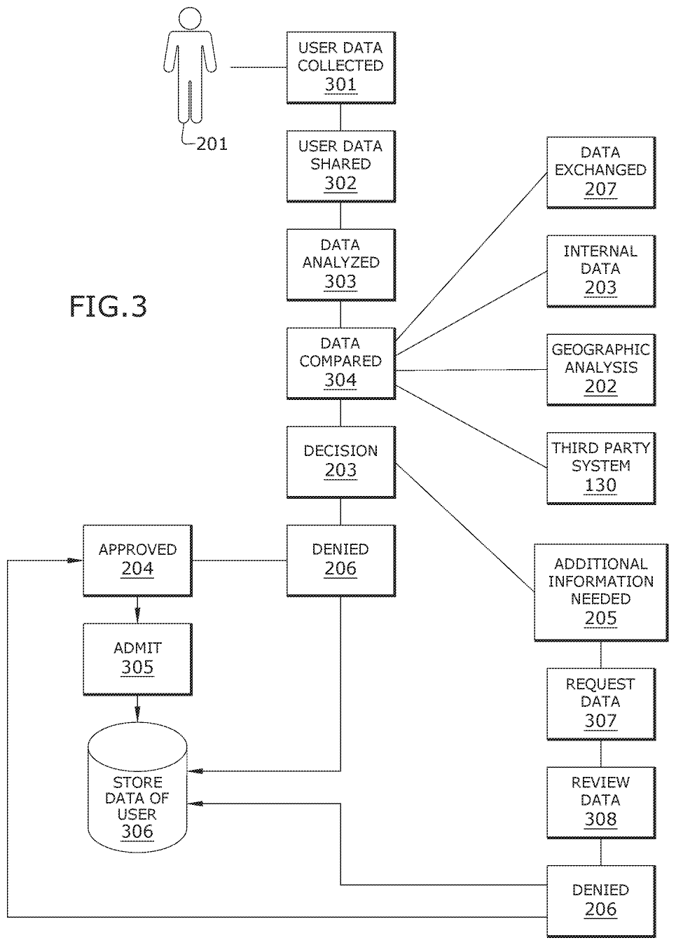

FIG. 3 is a flowchart of the decision-making process of the cannabis identity system 140 when an individual's 201 data is collected 301 according to an exemplary embodiment. Whether in-person or online, user data is collected 301, as based upon the user's 150 configurations to identity and verification of individuals 201. The individual enters their data 301, such as their full name, address, scanned copy of the front and back of their driver's license or another ID, social security, or other criteria required by the user 150. In one embodiment, a user 150 of a cannabis website requires that the individual 201 enter in their full name, driver license number, and address to verify the individual 201 prior to entering the website. Once the individual's data is collected 301, it is subsequently stored 302. The individual's data is either temporarily or permanently stored 302, as per regulations. The individual's data is analyzed 303 to determine the type of data present that was entered or provided. In one embodiment, the individual 201 has entered their full name and driver's license; as such, the cannabis identity system 140 analyzes the data to determine it is in the appropriate format and the type of data, such as a name and a driver's license. Once the data is analyzed 303, the data may be compared 304 against different data sources, such as data exchanges 207, internal data 203, geographic analysis 202, and third-party systems 130. In one embodiment, the individual's 201 driver's license may be compared 304 against a third-party system 130. In another embodiment, the individual's 201 name and address is compared 304 against data exchanged 207 within the cannabis identity system to determine if the individual 201 has visited other cannabis businesses or websites and if his identity matches based upon those visits.

After the data is compared 304 against different data sources, the cannabis identity system 140 either provides an approval 204, denial 206, or requires additional information 205. If approved, the individual 201 may be admitted or a transaction completed 305. The individual's 201 data may be stored. The data may be stored 306 for future usage by either the individual 201 or between other users 150 within the cannabis identity system 140. In one embodiment, the individual entered their full name, address, and drivers' licenses and was approved to enter a cannabis website; as such, the individual's 201 information is stored 306 and when the individual 201 either returns to the same website or goes to a cannabis facility, the information is subsequently matched and confirmed. If the individual is denied 205, then their information is stored 306 to prevent future issues. For example, in one embodiment, the individual 201 entered their name and a driver's license; however, it did not match and the individual 201 could not be verified; as such, the individual 201 was subsequently denied 206. In this embodiment, the individual's 201 information is stored 306 as not matching. If the individual 201 attempts to enter either another cannabis website or cannabis facility and uses the same information, then the individual 201 is subsequently verified. In addition, if the same individual 201 enters different data, then the cannabis identity system 140 analyzes 303 and compares 304 the data of the individual 201 to deny 206 the individual 201 as conflicting data. Another decision 203 may include the request for additional information 205 to properly verify the individual 201. Additional information needed 205 occurs when the individual's 201 information does not match and the user 150 does not configure a hard denial. The cannabis identity system 150 requires the user to submit additional information 307, as configured by the user 150 of either the cannabis website or cannabis facility. In one embodiment, an individual's 201 full name might not match a third-party system 130, such as publicly available data. In this embodiment, the cannabis identity system 140 requests 307 the individual 201 to either send additional documents or complete other items, as configured by the user 150. The requested data 307, when submitted by the individual 201, is reviewed by the cannabis identity system 140. The additional Based upon the review of data 308, the individual is either denied 206 or approved 204.

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of processes and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims. Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A computer program product for an online host platform verifying an identification of a cannabis purchasing individual, the computer program product comprising a non-transitory computer readable storage medium having computer readable program code embodied therewith, the computer readable program code being configured, when executed by a computer processor to:
host, through a computer server, the online host platform, wherein the online host platform is part of a computer network;
generate and host user interfaces for a plurality of user accounts, wherein the plurality of user accounts communicate with the computer server through the computer network;
receive by the computer server from one of the plurality of user accounts, identity data of the cannabis purchasing individual;
determine by the computer server, whether the identity data of the cannabis purchasing individual raises a flag associated with the cannabis purchasing individual; and
generate for display through the user interfaces, the flag associated with the cannabis purchasing individual.

2. The computer program product of claim 1, further comprising computer readable program code configured to: provide, through respective user interfaces, an input field for respective users to enter customized user defined rules for identifying customers.

3. The computer program product of claim 2, wherein the determination is based on the identity data breaking one of the user defined rules.

4. The computer program product of claim 1, wherein the flag is raised based on the identity data being inconsistency provided to two or more of the plurality of user accounts.

5. The computer program product of claim 1, further comprising computer readable program code configured to: request additional information from the individual to verify the identity of the individual.

6. A method for an online host platform verifying an identification of a cannabis purchasing individual, comprising:
hosting, through a computer server, the online host platform, wherein the online host platform is part of a computer network;
generating and host user interfaces for a plurality of user accounts, wherein the plurality of user accounts communicate with the computer server through the computer network;
receiving by the computer server from one of the plurality of user accounts, identity data of the cannabis purchasing individual;
determining by the computer server, whether the identity data of the cannabis purchasing individual raises a flag associated with the cannabis purchasing individual; and
generating for display through the user interfaces, the flag associated with the cannabis purchasing individual.

7. The method of claim 6, further comprising providing, through respective user interfaces, an input field for respective users to enter customized user defined rules for identifying customers.

8. The method of claim 7, wherein the determination is based on the identity data breaking one of the user defined rules.

9. The method of claim 6, wherein the flag is raised based on the identity data being inconsistently provided to two or more of the plurality of user accounts.

10. The method of claim 6, further comprising requesting additional information from the individual to verify the identity of the individual.
